(19) United States
(12) Patent Application Publication
(10) Pub. No.: US 2015/0104244 A1
(43) Pub. Date: Apr. 16, 2015

(54) LASER JOINT STRUCTURE AND LASER JOINING METHOD

(71) Applicant: TOYOTA JIDOSHA KABUSHIKI KAISHA, Toyota-shi (JP)

(72) Inventors: Akiyoshi WATANABE, Toyota-shi (JP); Norimasa KOREISHI, Toyota-shi (JP); Kentaro ADACHI, Toyota-shi (JP)

(21) Appl. No.: 14/513,495

(22) Filed: Oct. 14, 2014

(30) Foreign Application Priority Data
Oct. 16, 2013 (JP) 2013-215568

(51) Int. Cl. B23K 26/24

(52) U.S. Cl. CPC B23K 26/246
USPC 403/271; 219/121.64

(57) ABSTRACT

A laser joint structure includes a metal outer cylinder, a metal inner member that is provided inside of the outer cylinder, in which a joining portion is arranged following an inner shape of the outer cylinder, the joining portion being arranged contacting or close to the outer cylinder; and a laser weld that is provided on a mating portion of the outer cylinder and a corresponding mating portion of the joining portion, and in which a circular cylindrical nugget is formed by melting the outer cylinder and the joining portion, which is accomplished by emitting a laser light from outside the outer cylinder.

### INCORPORATION BY REFERENCE

The disclosure of Japanese Patent Application No. 2013-215568 filed on Oct. 16, 2013 including the specification, drawings and abstract is incorporated herein by reference in its entirety.

### BACKGROUND OF THE INVENTION

1. Field of the Invention

The invention relates to a laser joint structure and a laser joining method.

2. Description of Related Art

Japanese Patent Application Publication No. 11-47967 (JP 11-47967 A) describes a joining method for joining two plate members together using laser light. With this joining method, the plate members are coated with a coating material such as a zinc coating, and a predetermined gap must be provided between the plate members to allow the coating material vapor generated at the time of welding to escape. Therefore, a protruding portion (a concavo-convex portion) is first formed on the surface by emitting a predetermined laser light at a welding surface of one of the plate members in advance, and then the other plate member is overlapped with the side of the welding surface where this protruding portion is formed, such that a predetermined gap is provided between the two plate members. In this state, the two plate members are welded together by emitting the laser light for welding onto the overlapping portion.

In JP 11-47967 A, the predetermined gap is able to be provided between the two plate members by the protruding portion formed on one of the plate members. However, when an inner member such as a cylinder arranged following an inner shape of a cylindrical body (a circle, square, or hexagon or the like) is arranged inside of the cylindrical body, and the cylindrical body and the inner member are welded together by laser light, for example, it is difficult to ensure a predetermined gap between the cylindrical body and the inner member even when a protruding portion is formed on one of the cylindrical body and the inner member. For example, if the height of the protruding portion is formed small, the gap between the cylindrical body and the inner member on the side where the inner member is arranged via the protruding portion is set at approximately the height of the protruding portion, but the gap between the cylindrical body and the inner member on the side opposite the protruding portion may be too large, which may affect the weld quality.

### SUMMARY OF THE INVENTION

The invention thus provides a laser joint structure and a laser joining method in which weld quality is ensured without the need for a protruding portion when welding an outer cylinder and an inner member together by laser light.

A first aspect of the invention relates to a laser joint structure that includes a metal outer cylinder, a metal inner member, and a laser weld. The metal inner member is provided inside of the outer cylinder, and a joining portion is arranged following an inner shape of the outer cylinder. The joining portion is arranged contacting or close to the outer cylinder. The laser weld is provided on a mating portion of the outer cylinder and a corresponding mating portion of the joining portion. This laser weld is such that a circular cylindrical nugget is formed by melting the outer cylinder and the joining portion, which is accomplished by emitting a laser light from outside the outer cylinder.

According to this first aspect of the invention, a metal inner member is provided inside of the metal outer cylinder. The joining portion is arranged following the inner shape of the outer cylinder, on the inner member. The joining portion is arranged contacting or close to the outer cylinder. Then, the mating portion of the outer cylinder and the corresponding mating portion of the joining portion are joined together by providing a laser weld in which a circular cylindrical nugget is formed by melting the outer cylinder and the joining portion, which is accomplished by emitting the laser light from outside the outer cylinder, on the mating portions of the outer cylinder and the joining portion. With this laser joint structure, there is no need to provide a protruding portion for creating a gap between the outer cylinder and the joining portion, on one of the joining portion of the inner member and the outer cylinder. Because there is no protruding portion, welding is possible, without the gap between the outer cylinder and the inner member being that wide, even if the inner member is manufactured smaller than the design value. As a result, weld quality of the mating portions of the outer cylinder and the inner member is able to be ensured.

A second aspect of the invention relates to laser joining method that includes arranging a metal inner member having a joining portion arranged following an inner shape of a metal outer cylinder, inside of the outer cylinder, and arranging the joining portion contacting or close to the outer cylinder, and joining a mating portion of the outer cylinder with a corresponding mating portion of the joining portion by a laser weld in which a circular cylindrical nugget is formed by melting the outer cylinder and the joining portion, which is accomplished by emitting a laser light from outside the outer cylinder onto the mating portion of the outer cylinder and the corresponding mating portion of the joining portion.

According to this second aspect, the metal inner member having a joining portion arranged following an inner shape of a metal outer cylinder is arranged inside of the outer cylinder, and the joining portion is arranged contacting or close to the outer cylinder. Then, the mating portions are joined together by a laser weld in which a circular cylindrical nugget is formed by melting the outer cylinder and the joining portion, which is accomplished by emitting a laser light from outside the outer cylinder onto the mating portion of the outer cylinder and the corresponding mating portion of the joining portion. With this laser joining method, there is no need to provide a protruding portion for creating a gap between the outer cylinder and the joining portion, on one of the joining portion of the inner member and the outer cylinder. Because there is no protruding portion, welding is possible, without the gap between the outer cylinder and the inner member being that wide, even if the inner member is manufactured smaller than the design value. As a result, weld quality of the mating portions of the outer cylinder and the inner member is able to be ensured.

With the laser joint structure and laser joining method according to the invention, weld quality is able to be ensured without the need for a protruding portion when welding an outer cylinder and an inner member together by laser light.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a structural member to which a laser joint structure according to a first example embodiment of the invention has been applied;

FIG. 2 is a sectional view of the structural member taken along line II-II in FIG. 1, in a state in which an outer cylinder and an inner member are welded together by laser light;

FIG. 3A is a perspective view of the inner member used in the structural member shown in FIG. 1; and FIG. 3B is a developed view of the inner member;

FIG. 4A is a plan view illustrating a laser joining method for manufacturing the structural member shown in FIG. 1, and FIG. 4B is a sectional view of a laser weld of a mating portion of the outer cylinder and a corresponding mating portion of the inner member;

FIG. 5 is a perspective view of a structural member to which a laser joint structure according to a second example embodiment of the invention has been applied;

FIG. 6 is a sectional view of the structural member taken along line VI-VI in FIG. 5, in a state in which an outer cylinder and an inner member are welded together by laser light;

FIG. 7 is a perspective view of a structural member to which a laser joint structure according to a first comparative example has been applied; and

FIG. 8 is a perspective view of a structural member to which a laser joint structure according to a second comparative example has been applied.

### DETAILED DESCRIPTION OF EMBODIMENTS

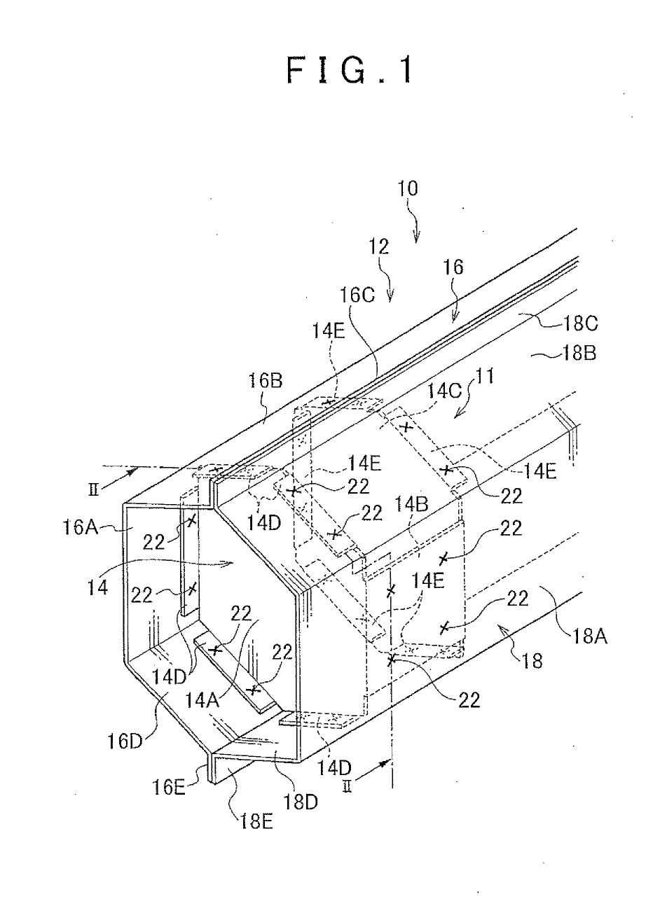

Hereinafter, a first example embodiment of a laser joint structure according to the invention will be described with reference to FIGS. 1 to 4.

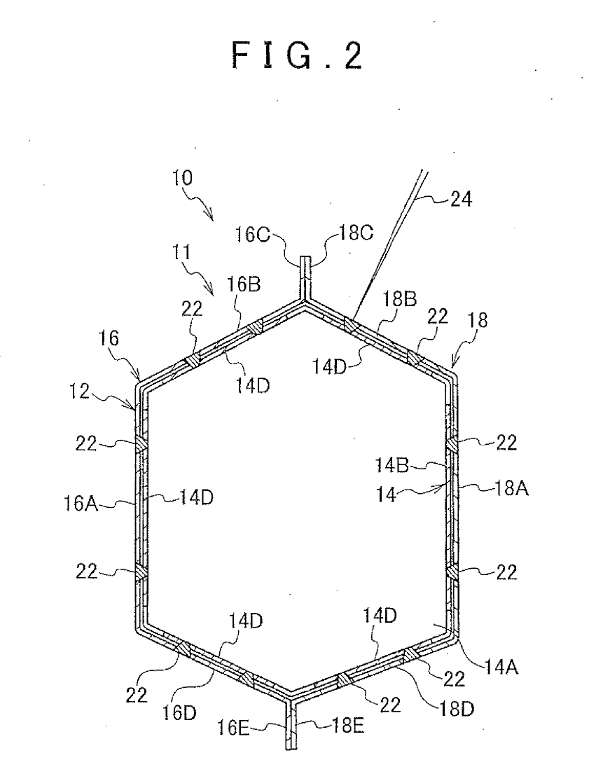

FIG. 1 is a perspective view of a structural member 10 to which a laser joint structure 11 according to this example embodiment has been applied. FIG. 2 is a sectional view of the structural member 10 taken along line II-II in FIG. 1. The terms upper, lower, and vertical, and lateral may be used with the upper-lower and left-right (lateral) directions in FIGS. 1 and 2 for the sake of convenience to facilitate understanding of the description. However, the actual structural member 10 is not intended to be arranged in space matching the upper-lower and left-right directions in FIGS. 1 and 2. That is, the direction in which the structural member 10 is arranged may be set as appropriate.

As shown in FIGS. 1 and 2, the structural member 10 to which the laser joint structure 11 has been applied includes an outer cylinder 12 of which a cross-section orthogonal to a length direction is a generally hexagonal closed cross-section, and a reinforcing member 14 that serves as an inner member arranged inside the outer cylinder 12. The outer cylinder 12 has a metal first panel member 16 arranged on one side in the lateral direction in FIG. 1 (i.e., on the far side in FIG. 1), and a metal second panel member 18 arranged on the other side in the lateral direction in FIG. 1 (i.e., on the near side in FIG. 1).

The first panel member 16 is formed having a cross-section orthogonal to the length direction that is generally hat-shaped. More specifically, the first panel member 16 has a vertical wall portion 16A arranged in the upper-lower direction in FIG. 1, an inclined wall portion 16B arranged extending at an angle upward from an upper end portion of the vertical wall portion 16A, a flange portion 16C extending upward from an upper end portion of the inclined wall portion 16B, an inclined wall portion 16D arranged extending at an angle downward from a lower end portion of the vertical wall portion 16A, and a flange portion 16E extending downward from a lower end portion of the inclined wall portion 16D.

The second panel member 18 is formed having a cross-section orthogonal to the length direction that is generally hat-shaped arranged facing the opposite direction of the first panel member 16. More specifically, the second panel member 18 has a vertical wall portion 18A arranged in the upper-lower direction in FIG. 1, an inclined wall portion 18B arranged extending at an angle upward from an upper end portion of the vertical wall portion 18A, a flange portion 18C extending upward from an upper end portion of the inclined wall portion 18B, an inclined wall portion 18D arranged extending at an angle downward from a lower end portion of the vertical wall portion 18A, and a flange portion 18E extending downward from a lower end portion of the inclined wall portion 18D.

The flange portion 16C of the first panel member 16 and the flange portion 18C of the second panel member 18 are joined together by welding or the like while in surface contact with each other. Also, the flange portion 16E of the first panel member 16 and the flange portion 18E of the second panel member 18 are joined together by welding or the like while in surface contact with each other. As a result, the outer cylinder 12 having a generally hexagonal closed cross-section is formed by the first panel member 16 and the second panel member 18.

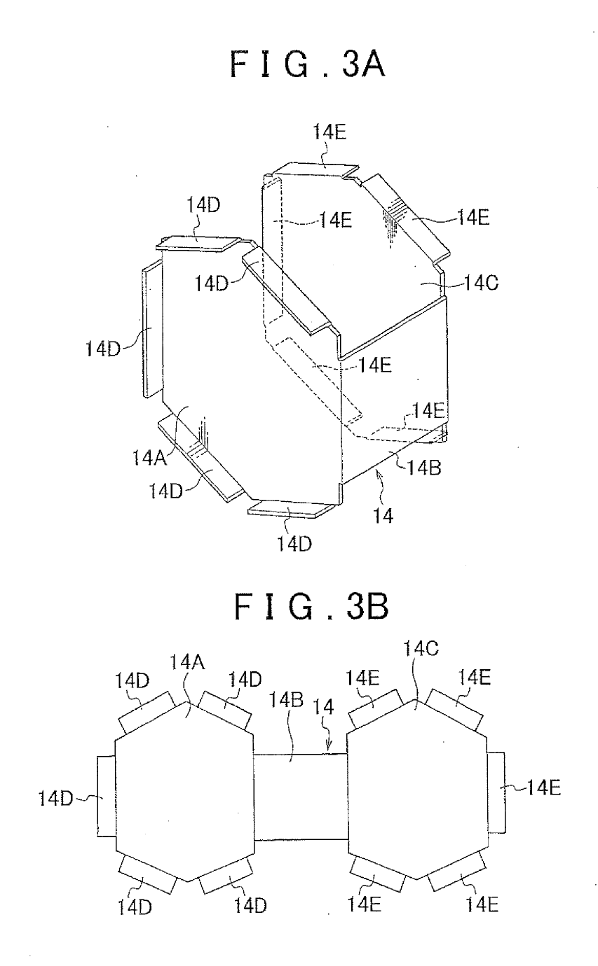

As shown in FIGS. 1 and 3A, the reinforcing member 14 is formed in one piece (i.e., formed by a single part). The reinforcing member 14 includes a planar wall portion 14A formed in a generally hexagonal shape, a connecting wall portion 14B that serves as a joining portion that is bent in a direction substantially orthogonal to the wall portion 14A from an end portion of the wall portion 14A, and a generally hexagonal planar wall portion 14C that is bent so as to face the wall portion 14A from an end portion of the connecting wall portion 14B (see the projection view of the reinforcing member 14 shown in FIG. 3B).

A flange portion 14D that serves as a joining portion that is bent in the opposite direction of the wall portion 14C, is formed on each side of a generally hexagonal shape of the wall portion 14A except for the side (position) where the connecting wall portion 14B is provided. That is, five flange portions 14D are formed on the wall portion 14A. Similarly, a flange portion 14E that serves as a joining portion that is bent in the opposite direction of the wall portion 14A, is formed on each side of a generally hexagonal shape of a wall portion 14C except for the side (position) where the connecting wall portion 14B is provided. That is, five flange portions 14E are formed on the wall portion 14C.

As shown in FIGS. 1 and 2, the reinforcing member 14 is arranged inside the outer cylinder 12 formed by the first panel member 16 and the second panel member 18. In a sectional view from the length direction of the structural member 10, the outer shape of the connecting wall portion 14B and the plurality of flange portions 14D of the wall portion 14A is arranged following the inner shape of the outer cylinder 12. In this example embodiment, the outer shape of the connecting wall portion 14B and the plurality of flange portions 14D of the wall portion 14A is set slightly smaller than the inner shape of the outer cylinder 12, such that the reinforcing member 14 is able to be arranged inside of the outer cylinder 12. The connecting wall portion 14B and the plurality of flange portions 14D of the wall portion 14A are arranged contacting or close to the outer cylinder 12 (see FIG. 2).

In FIG. 2, the connecting wall portion 14B and all of the flange portions 14D of the wall portion 14A are arranged close to the outer cylinder 12, with a substantially constant gap therebetween, but this is a view showing a frame format. In actuality, a portion of one of the connecting wall portion 14B and the plurality of flange portions 14D is arranged contacting the outer cylinder 12, and the other of the connecting wall portion 14B and the flange portions 14D is arranged dose to the outer cylinder 12, due to machining accuracy and dimensional tolerance and the like of the reinforcing member 14 and the outer cylinder 12. Also, when the other of the connecting wall portion 14B and the flange portions 14D is arranged close to the outer cylinder 12, the dimension of the gap therebetween is different at each position.

Similarly, in a sectional view from the length direction of the structural member 10, the outer shape of the plurality of flange portions 14E of the wall portion 14C is arranged following the inner shape of the outer cylinder 12. In this example embodiment, the outer shape of the plurality of flange portions 14E of the wall portion 14C is set slightly smaller than the inner shape of the outer cylinder 12, such that the plurality of flange portions 14E are able to be arranged contacting or close to the outer cylinder 12.

The mating portion of the connecting wall portion 14B and the mating portion of the outer cylinder 12 (i.e., the portions of these that are arranged close together or contacting each other) are joined together by a laser weld 22. Also, the mating portions of the plurality of the flange portions 14D of the wall portion 14A and the mating portion of the outer cylinder 12 (i.e., the portions of these that are arranged close together or contacting each other) are joined together by a laser weld 22. More specifically, as shown in FIG. 2, a laser light 24 is emitted from outside the outer cylinder 12 onto the mating portion of the connecting wall portion 14B and mating portion of the outer cylinder 12, and the mating portions of the plurality of flange portions 14D and the mating portion of the outer cylinder 12. At this time, the mating portions of the connecting wall portion 14B and the outer cylinder 12, and the mating portions of the flange portions 14D and the outer cylinder 12 are joined together by providing the laser weld 22 in which a circular cylindrical nugget is formed by melting the outer cylinder 12 and the connecting wall portion 14B and the flange portions 14D by laser screw welding (hereinafter, referred to as “LSW”) that will be described later. The laser welds 22 are indicated by an “X” in FIG. 1 to facilitate understanding of the weld locations.

When the laser light 24 is emitted from outside the outer cylinder 12 by LSW, a gap may be formed between the outer cylinder 12, and the connecting wall portion 14B and the plurality of flange portions 14D. In this case, the gap between the outer cylinder 12, and the connecting wall portion 14B and the flange portions 14D is preferably set to within the plate thickness of the outer cylinder 12 at a welded portion.

For example, if the plate thickness (i.e., the thickness) of the outer cylinder 12 is approximately 1.0 mm, the gap between the outer cylinder 12, and the connecting wall portion 14B and the flange portions 14D is preferably set to 1.0 mm or less. In this case, welding is possible regardless of whether the plate thickness of the connecting wall portion 14B and the plurality of flange portions 14D is set to equal to or greater than 1.0 mm, or less than 1.0 mm. That is, when the plate thickness of the outer cylinder 12 is 1.0 mm, for example, welding is possible as long as the gap between the outer cylinder 12, and the connecting wall portion 14B and the plurality of flange portions 14D is between 0 and 1.0 mm, inclusive. By adjusting the gap in this way, the laser weld 22 is able to be more reliably formed at the mating portions of the outer cylinder 12 and the connecting wall portion 14B, and the mating portions of the outer cylinder 12 and the plurality of flange portions 14D, so weld quality is able to be ensured. That is, the laser weld 22 in which a circular cylindrical nugget is formed on the mating portions of outer cylinder 12 and the joining portion when the laser light is emitted from outside the outer cylinder 12, is able to be provided on the mating portions of the outer cylinder 12 and the joining portion, so weld quality is able to be ensured.

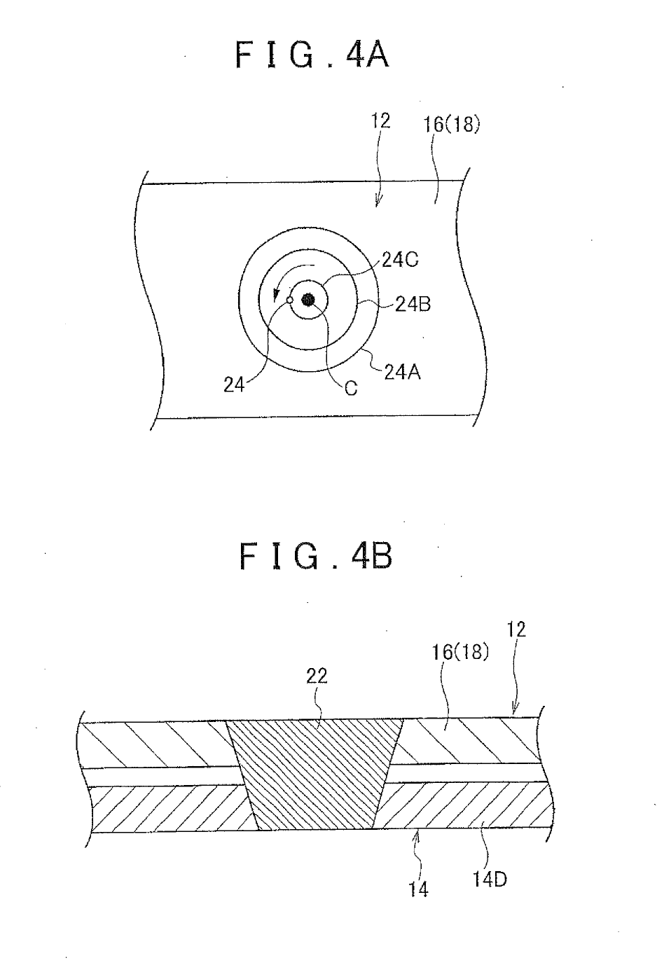

As shown in FIG. 4A, when joining the mating portions of the outer cylinder 12 and the flange portions 14D of the reinforcing member 14 together, as shown in FIG. 4A, the mating portions are joined by LSW. At this time, at least one of the outer cylinder 12 or the reinforcing member 14 may be coated (surface finished). First, a first scan with the laser light 24 is performed following the weld shape centered on a center position C when viewed from above, creating a scan path 24A having a generally circular shape (this is substantially the same as when joining using a typical line laser). Then, with LSW in this example embodiment, a second and third scans with the laser light 24 are performed so as to create substantially the same scan path as the scan path 24A. Next, a fourth scan with the laser light 24 is performed to the radial inside of the scan path 24A, creating a generally circular scan path 24B. Further, a fifth scan with the laser light 24 is performed to the radial inside of the scan path 24B, creating a generally circular scan path 24C.

As a result, the laser weld 22 in which a circular cylindrical nugget is formed by melting the outer cylinder 12 and the flange portions 14D is provided on the mating portions of the outer cylinder 12 and the flange portions 14D of the reinforcing member 14, as shown in FIG. 4B. The flange portions 14D are able to be welded to the outer cylinder 12 by this laser weld 22. It is sufficient that a plurality of scan paths be created by performing the scan with the laser light 24 a plurality of times in a generally circular shape centered around the center position C, but the number of scans with the laser light 24 may be changed.

Similarly, the mating portions of the plurality of flange portions 14E of the wall portion 14C and the mating portion of the outer cylinder 12 (i.e., the portions of these that are arranged close together or contacting each other) are joined together by the laser weld 22. That is, the laser light 24 is emitted a plurality of times from outside the outer cylinder 12 onto the mating portions of the plurality of flange portions 14E and the mating portion of the outer cylinder 12, and these mating portions are joined together by LSW. As a result, the mating portions of the flange portions 14E of the wall portion 14C and the mating portion of the outer cylinder 12 are able to be joined together by providing the laser weld 22 in which a circular cylindrical nugget is formed by melting the outer cylinder 12 and the flange portions 14E.

In this kind of structural member 10, the outer cylinder 12 is formed by the two panel members, i.e., the first panel member 16 and the second panel member 18, that are divided in the circumferential direction, and the reinforcing member 14 that is formed in one piece is arranged straddling the first panel member 16 and the second panel member 18. In other words, the outer cylinder 12 includes the first panel member 16 and the second panel member 18. In the outer cylinder 12, the first panel member 16 and the second panel member 18 are provided in the circumferential direction. In this state, the plurality of flange portions 14D and flange portions 14E of the reinforcing member 14 are joined to the first panel member 16 and the second panel member 18, respectively, and the connecting wall portion 14B is joined to the second panel member 18.

In this example embodiment, the mating portion of the outer cylinder 12 (i.e., the first panel member 16 and the second panel member 18) is joined together with the mating portion of each of the flange portions 14D and 14E of the reinforcing member 14 by two laser welds 22; The mating portions of the second panel member 18 and the connecting wall portion 14B of the reinforcing member 14 are joined together by four laser welds 22. The number of laser welds 22 is not limited to the number in this example embodiment, and may be changed.

In this example embodiment, when joining by LSW, a scan with the laser light 24 is performed a plurality of times in a generally concentric shape, but the scan is not limited to this. For example, a laser weld in which a generally circular cylindrical nugget is formed may be provided by performing a scan with the laser light 24 a plurality of times in an elliptical shape, a semicircular shape, or a multi-angular shape, or by scanning in a spiral shape.

In this example embodiment, the material used to form the first panel member 16, the second panel member 18, and the reinforcing member 14 may be any material as long as it is metal material that can be welded. For example, steel sheet, or aluminum alloy or the like may be used for the material.

The structural member 10 in this example embodiment is used in an automobile, a railcar, or a construction member, for example.

Here, a laser joining method for manufacturing the structural member 10 will be described.

First, the outer cylinder 12 is prepared using the first panel member 16 and the second panel member 18. As shown in FIG. 1, the flange portion 16C of the first panel member 16 and the flange portion 18C of the second panel member 18 are made to surface contact each other, and the flange portion 16E of the first panel member 16 and the flange portion 18E of the second panel member 18 are made to surface contact each other. In this state, the flange portion 16C is joined to the flange portion 18C by welding (any type of welding, such as spot welding or line laser welding) or the like, and the flange portion 16E is joined to the flange portion 18E by welding (any type of welding, such as spot welding or line laser welding) or the like. As a result, the outer cylinder 12 having a generally hexagonal closed cross-section is formed by the first panel member 16 and the second panel member 18.

Furthermore, the reinforcing member 14 is arranged inside the outer cylinder 12. At this time, the outer cylinder 12 may be formed and then the reinforcing member 14 may be inserted into the outer cylinder 12, or the reinforcing member 14 may be arranged and then the outer cylinder 12 may be formed around the reinforcing member 14. Moreover, the plurality of the flange portions 14D of the wall portion 14A are arranged contacting or close to the inner surface of the outer cylinder 12 (i.e., the first panel member 16 and the second panel member 18), and the connecting wall portion 14B is arranged contacting or close to the inner surface of the second panel member 18. Also, the plurality of the flange portions 14E of the wall portion 14C are arranged contacting or close to the inner surface of the outer cylinder 12 (i.e., the first panel member 16 and the second panel member 18). In this example embodiment, the connecting wall portion 14B is arranged on the second panel member 18 side, but it is not limited to this. That is, the connecting wall portion 14B may also be arranged on the first panel member 16 side.

At this time, the dimension of the gap between the outer cylinder 12 (i.e., the first panel member 16 and the second panel member 18) and the plurality of flange portions 14D and 14E may fluctuate slightly from the dimension of the gap between the connecting wall portion 14B and the second panel member 18 due to machining accuracy and dimensional tolerance and the like of the reinforcing member 14 and the outer cylinder 12, but the dimensions of these gaps are able to be adjusted so that they are within the plate thickness (e.g., 1.0 mm) of the outer cylinder 12.

Then, the laser light 24 is emitted from outside the outer cylinder 12 onto the mating portion of the outer cylinder 12 (i.e., the first panel member 16 and the second panel member 18) and the mating portions of the plurality of flange portions 14D of the reinforcing member 14, the mating portion of the second panel member 18 and the mating portion of the connecting wall portion 14B of the reinforcing member 14, and the mating portion of the outer cylinder 12 (i.e., the first panel member 16 and the second panel member 18) and the mating portions of the plurality of flange portions 14E of the reinforcing member 14, in this order. At this time, the laser weld 22 in which a circular cylindrical nugget is formed by melting the outer cylinder 12 and the reinforcing member 14 is provided using LSW. As a result, the mating portion of the outer cylinder 12 and the connecting wall portion 14B, the mating portion of the outer cylinder 12 and the mating portions of the plurality of flange portions 14D and 14E of the reinforcing member 14 are joined together by a plurality of laser welds 22.

Next, the operation and effect of the laser joint structure 11 of this example embodiment will be described.

The reinforcing member 14 includes the connecting wall portion 14B and the plurality of flange portions 14D and 14E arranged following the inner shape of the outer cylinder 12, and the connecting wall portion 14B and the plurality of flange portions 14D and 14E are arranged contacting or close to the inner surface of the outer cylinder 12. Then the laser weld 22 in which a circular cylindrical nugget is formed by melting the outer cylinder 12, and the connecting wall portion 14B and the plurality of flange portions 14D and 14E is provided by emitting the laser light 24 from outside the outer cylinder 12 onto the mating portion of the outer cylinder 12 and the mating portion of the connecting wall portion 14B and the mating portion of the outer cylinder 12 and the mating portions of the plurality of flange portions 14D and 14E. The mating portion of outer cylinder 12 and the mating portion of the connecting wall portion 14B, and the mating portion of outer cylinder 12 and the mating portions of the plurality of flange portions 14D and 14E are joined together by providing a plurality of these laser welds 22.

With this kind of laser joint structure 11, a protruding portion for creating a gap between the outer cylinder 12, and the connecting wall portion 14B and the plurality of flange portions 14D and 14E does not need to be provided on one of the outer cylinder 12 and the reinforcing member 14. Because there is no protruding portion, joining by LSW is possible, without the gap between the outer cylinder and the inner member being that wide, even if the reinforcing member 14 is manufactured smaller than the design value.

Further, with the laser joint structure 11, a gap is formed between some or all of the connecting wall portion 14B and the plurality of flange portions 14D and 14E and the outer cylinder 12 before welding by the laser light 24, and the dimension of the gap is set to be within the plate thickness (e.g., 1.0 mm) of the outer cylinder 12. As a result, when the laser light 24 is emitted from outside the outer cylinder 12 onto the mating portions of the outer cylinder 12 and the connecting wall portion 14B, and the mating portions of the outer cylinder 12 and the plurality of flange portions 14D and 14E, the laser weld 22 in which a circular cylindrical nugget is formed by melting the outer cylinder 12 and the reinforcing member 14 by LSW is able to be provided. Therefore, the weld quality of the mating portion of the outer cylinder 12 and the mating portion of the connecting wall portion 14B, and the mating portion of the outer cylinder 12 and the mating portions of the plurality of flange portions 14D and 14E is able to be ensured.

Also, the reinforcing member 14 includes the plurality of flange portions 14D that are bent from the wall portion 14A, and the plurality of flange portions 14E that are bent from the wall portion 14C, and the plurality of flange portions 14D and 14E are easily arranged close to or contacting the outer cylinder 12. Therefore, each of the mating portions of the outer cylinder 12 and the plurality of flange portions 14D and 14E is able to be welded.

Furthermore, the outer cylinder 12 is formed by the two panel members, i.e., first panel member 16 and the second panel member 18, that are divided in the circumferential direction, and the reinforcing member 14 that is formed in one piece is arranged straddling the first panel member 16 and the second panel member 18. Then the plurality of flange portions 14D and 14E of the reinforcing member 14 are joined to the first panel member 16 and the second panel member 18, respectively, and the connecting wall portion 14B of the reinforcing member 14 is joined to the second panel member 18. As a result, the reinforcing member 14 that is formed in one piece is able to be joined over multiple surfaces to the first panel member 16 and the second panel member 18, so the strength and rigidity of the structural member 10 are able to be efficiently improved.

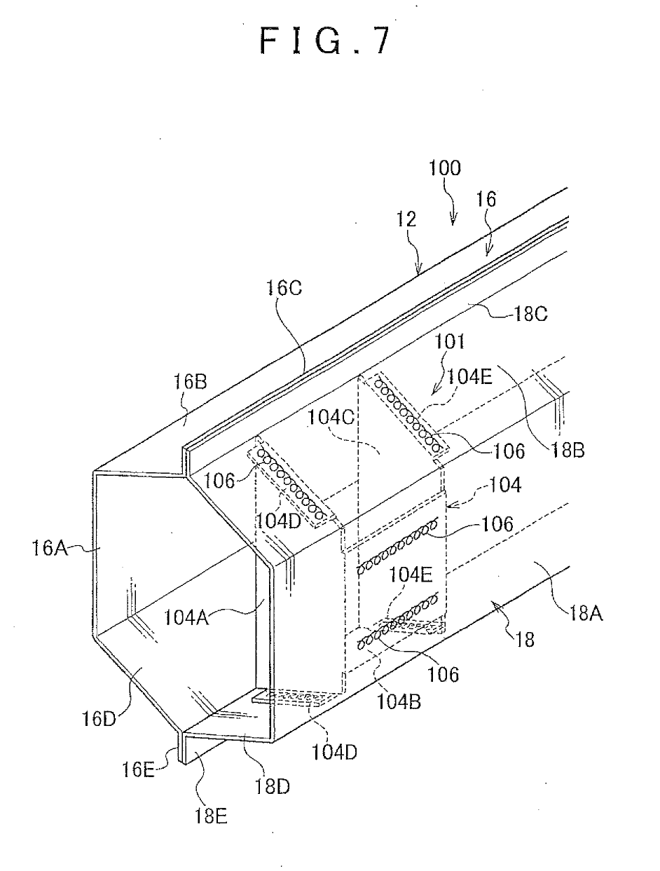

FIG. 7 is a perspective view of a structural member 100 to which a laser joint structure 101 according to a first comparative example has been applied. As shown in FIG. 7, with this structural member 100, a reinforcing member 104 is arranged inside of the outer cylinder 12 formed by the first panel member 16 and the second panel member 18. The reinforcing member 104 includes a planar wall portion 104A formed in a generally trapezoidal shape following the inner surface of the second panel member 18, a connecting wall portion 104B that is bent from an end portion of the wall portion 104A, and a generally trapezoidal planar wall portion 104C that is bent so as to face the wall portion 104A from an end portion of the connecting wall portion 104B.

A flange portion 104D that is bent in the opposite direction of the wall portion 104C, is formed on both sides of the side (position) where the connecting wall portion 104B of a wall portion 104A is provided. A flange portion 14E that is bent in the opposite direction of the wall portion 104A, is formed on both sides of the side (position) where the connecting wall portion 104B of the wall portion 104C is provided. The two flange portions 104D, the connecting wall portion 104B, and the two flange portions 104E of the reinforcing member 104 are arranged so as to almost contact the inner surface of the second panel member 18. In this state, the two flange portions 104D, the connecting wall portion 104B, and the two flange portions 104E of the reinforcing member 104, are joined to the second panel member 18 by a weld 106 formed by emitting a line laser from the second panel member 18 side.

When joining by line laser, the two flange portions 104D, the connecting wall portion 104B, and the two flange portions 104E of the reinforcing member 104 must be arranged almost surface contacting the second panel member 18. A test conducted by the inventors confirmed that when joining together two members by line laser, weld quality is unable to be ensured unless the gap between the two members is set to 0.1 to 03 mm, inclusive. Therefore, the reinforcing member 104 is only able to be joined in a cross-section of the second panel member 18 that is one of the panel members of first panel member 16 and the second panel member 18 due to dimensional tolerance and machining accuracy and the like of the members. That is, when joining is performed by line laser, a reinforcing member is unable to be provided straddling the first panel member 16 and the second panel member 18.

Also, Japanese Patent Application Publication No. 2010-155509 (JP 2010-155509 A) describes a structure in which a reinforcing member is provided on each of a rocker inner and a rocker outer formed having a hat-shaped cross-section, as a rocker for a vehicle. With this structure, the rocker outer is joined to one reinforcing member by spot welding, and the rocker inner is joined to the other reinforcing member by spot welding. With this structure as well, a reinforcing member that is integrally formed straddling the rocker outer and the rocker inner is unable to be provided.

Also, Japanese Patent Application Publication No. 2010-143461 (JP 2010-143461 A) describes a structure in which a reinforcing member is provided via a resin member that is adhered by an adhesive to a rocker inner and a rocker outer having a hat-shaped cross-section. With this structure, the adhesive and the resin member are used, so it is difficult to perform joining in which accuracy is ensured, due to variation in parts.

In contrast, with the laser joint structure 11 of the example embodiment, the laser weld 22 in which a circular cylindrical nugget is formed by melting the joining portion of the reinforcing member 14 and the outer cylinder 12 by LSW is able to be provided by adjusting the dimension of the gap between the outer cylinder 12 and the joining portion of the reinforcing member 14 so that it is within the plate thickness of the outer cylinder 12, for example, as shown in FIG. 1 and the like. Therefore, the reinforcing member 14 is able to be provided in the cross-section of the first panel member 16 and the second panel member 18.

With the laser joint structure 11 of the example embodiment, the connecting wall portion 14B and all of the five flange portions 14D and 14E of the reinforcing member 14 are joined to the entire generally hexagonal surface of the outer cylinder 12 by the laser weld 22, but they are not limited to this. For example, any two or more of the connecting wall portion 14B and the five flange portions 14D (or the five flange portions 14E) of the reinforcing member 14 may be joined to any two or more generally hexagonal surfaces of the outer cylinder 12 by the laser weld 22. In this case, two or more of the connecting wall portion 14B and the five flange portions 14D (or the five flange portions 14E) of the reinforcing member 14 that face the outer cylinder 12 are preferably joined to the outer cylinder 12 by the laser weld 22.

Also, in this example embodiment, the outer cylinder 12 is formed by two panel members, i.e., the first panel member 16 and the second panel member 18, that are divided in the circumferential direction, but the outer cylinder 12 is not limited to this. For example, the outer cylinder may also be formed by a plurality of members that are divided in the circumferential direction. As a result, the inside member formed in one piece is joined over multiple surfaces to the plurality of members, so the strength and rigidity are able to be effectively improved.

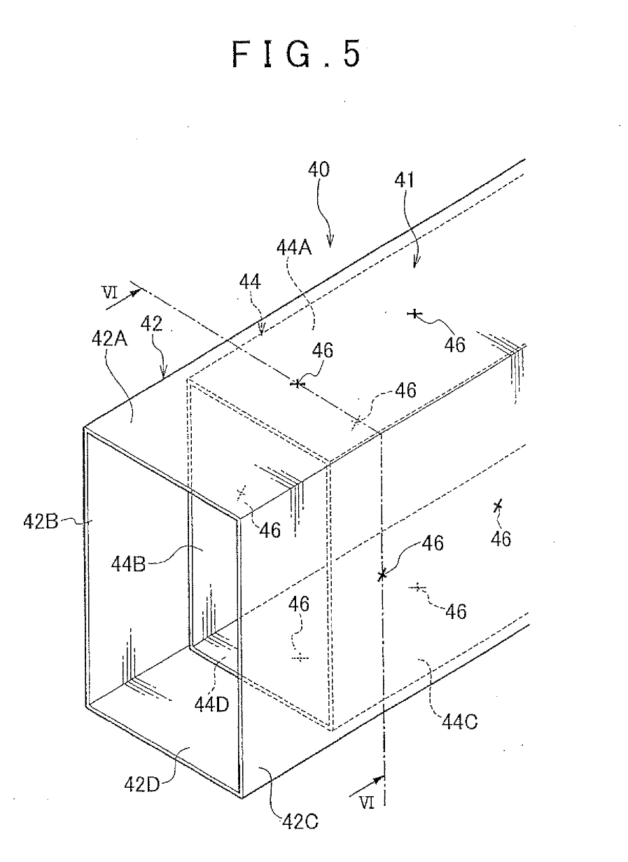

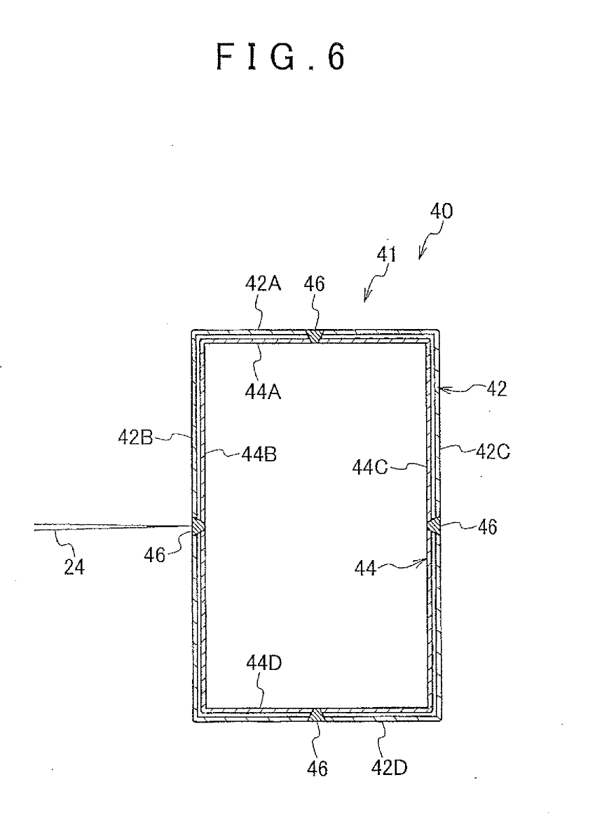

Next, a second example embodiment of the laser joint structure according 6 to the invention will be described with reference to FIGS. 5 and 6. Component parts in the second example embodiment that are similar to component parts in the first example embodiment described above will be denoted by like reference characters, and descriptions thereof will be omitted.

As shown in FIGS. 5 and 6, a structural member 40 to which a laser joint structure 41 of this example embodiment has been applied has an inner cylinder 44 that serves as an inner member arranged inside of an outer cylinder 42. The outer cylinder 42 is formed by a metal cylindrical body that is formed in a generally rectangular shape. More specifically, the outer cylinder 42 includes a generally planar lateral wall portion 42A arranged on an upper side in the upper-lower direction in FIGS. 5 and 6, generally planar vertical wall portions 42B and 42C that are bent downward on both end portions of the lateral wall portion 42A, and a generally planar lateral wall portion 42D that connects lower end portions of these vertical wall portions 42B and 42C together.

The inner cylinder 44 is formed by a metal cylindrical body arranged following the inner shape of the outer cylinder 42. More specifically, the inner cylinder 44 includes a generally planar lateral wall portion 44A arranged on an upper side in the upper-lower direction in FIGS. 5 and 6, generally planar vertical wall portions 44B and 44C that serve as joining portions and are bent downward on both end portions of the lateral wall portion 44A, and a generally planar lateral wall portion 44D that serves as a joining portion and connects lower end portions of these vertical wall portions 44B and 44C together.

The outer shape of the inner cylinder 44 is formed slightly smaller than the inner shape of the outer cylinder 42, and functions as a reinforcing member by being arranged inside the outer cylinder 42. The outer cylinder 42 and the inner cylinder 44 each has a closed sectional shape formed in one piece, and is formed by a roll-formed member, an extruded member, or a hydro-formed member or the like.

As shown in FIG. 6, the lateral wall portion 44A of the inner cylinder 44 is arranged contacting or close to the lateral wall portion 42A of the outer cylinder 42, and the vertical wall portions 44B and 44C of the inner cylinder 44 are arranged contacting or close to the vertical wall portions 42B and 42C of the outer cylinder 42. The lateral wall portion 44D of the inner cylinder 44 is arranged contacting or close to the lateral wall portion 42D of the outer cylinder 42.

The mating portion of the outer cylinder 42 and the mating portion of the lateral wall portion 44A, the mating portion of the outer cylinder 42 and the mating portion of the vertical wall portion 44B, the mating portion of the outer cylinder 42 and the mating portion of the vertical wall portion 44C, and the mating portion of the outer cylinder 42 and the mating portion of the lateral wall portion 44D of the inner cylinder 44 are each joined together by a laser weld 46. More specifically, the laser light 24 from outside the outer cylinder 42 is emitted onto the mating portions of the outer cylinder 42, and the lateral wall portion 44A, the vertical wall portions 44B and 44C, and the lateral wall portion 44D of the inner cylinder 44, as shown in FIG. 6. At this time, the mating portions of the outer cylinder 42, and the lateral wall portion 44A, the vertical wall portions 44B and 44C, and the lateral wall portion 44D of the inner cylinder 44 are joined together by providing the laser weld 46 in which a circular cylindrical nugget is formed by melting the outer cylinder 42 and the inner cylinder 44 by LSW.

A gap may be formed between the outer cylinder 42 and the inner cylinder 44 when emitting the laser light 24 from outside the outer cylinder 42. In this case, the dimension of the gap between the outer cylinder 42 and the inner cylinder 44 is preferably set to be within the plate thickness of the outer cylinder 42.

With this kind of laser joint structure 41, a protruding portion for creating a gap between the outer cylinder 42 and the inner cylinder 44 does not need to be provided on one of the outer cylinder 42 and the inner cylinder 44. Because there is no protruding portion, joining by LSW is possible, without the gap between the outer cylinder and the inner member being that wide, even if the inner cylinder 44 is manufactured smaller than the design value. As a result, weld quality of the mating portions of the outer cylinder 42 and the inner cylinder 44 is able to be ensured.

Also, the four surfaces of the inner cylinder 44 that is formed in one piece are joined by the laser welds 46 to the four surfaces of the outer cylinder 42 that is also formed in one piece. Therefore, the strength and rigidity of the structural member 40 are able to be efficiently improved.

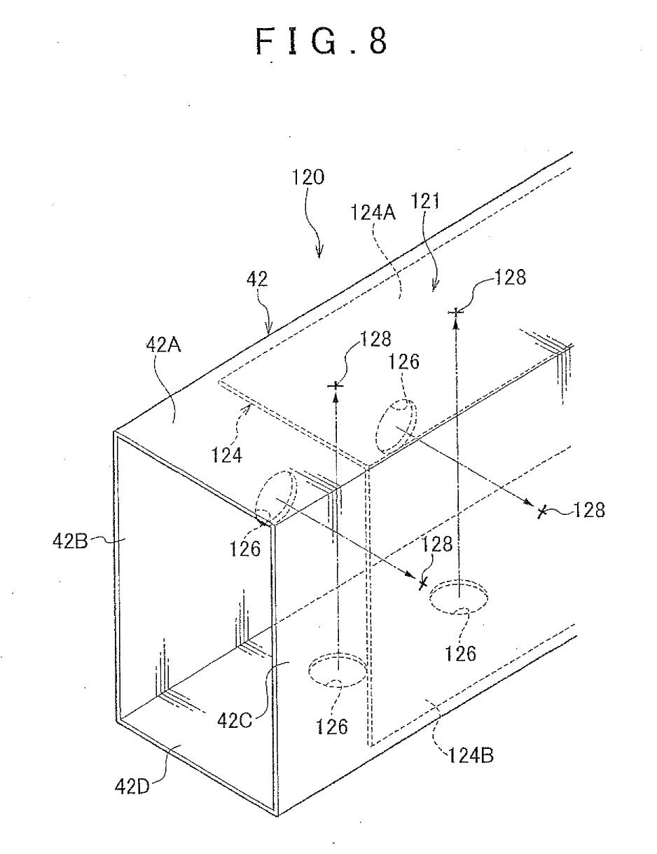

FIG. 8 is a perspective view of a structural member 120 to which a joint structure 121 by spot welding of a second comparative example has been applied. As shown in FIG. 8, with the structural member 120, a reinforcing member 124 is arranged inside of the outer cylinder 42 that is integrally formed. The reinforcing member 124 is formed in a general L-shape in a sectional view. More specifically, the reinforcing member 124 includes a planar lateral wall portion 124A arranged following an inner surface of the lateral wall portion 42A on the upper side in FIG. 8, and a vertical wall portion 124B that is bent from an end portion of the lateral wall portion 124A and arranged following the inner surface of the vertical wall portion 42C.

The lateral wall portion 124A of the reinforcing member 124 are arranged in surface contact with the lateral wall portion 42A of the outer cylinder 42, and the vertical wall portion 124B of the reinforcing member 124 is arranged in surface contact with the vertical wall portion 42C of the outer cylinder 42. A plurality of circular openings 126 (i.e., two in this example embodiment) are formed corresponding to weld positions, in the lateral wall portion 42D of the outer cylinder 42 that faces the lateral wall portion 124A of the reinforcing member 124. A plurality of the circular openings 126 (i.e., two in this example embodiment) are also formed corresponding to weld positions, in the vertical wall portion 42B of the outer cylinder 42 that faces the vertical wall portion 124B of the reinforcing member 124. These openings 126 are formed for inserting welding guns (electrodes) for spot welding.

That is, spot welding is performed by inserting one welding gun from the opening 126 in the lateral wall portion 42D, and bringing a pair of welding guns into contact from both sides of the contact surface of the lateral wall portion 124A of the reinforcing member 124 and the lateral wall portion 42A of the outer cylinder 42. As a result, the lateral wall portion 124A of the reinforcing member 124 is joined to the lateral wall portion 42A of the outer cylinder 42 by a spot weld 128. Also, spot welding is performed by inserting one welding gun from the opening 126 in the vertical wall portion 42B, and bringing a pair of welding guns into contact from both sides of a contact surface of the vertical wall portion 124B of the reinforcing member 124 and the vertical wall portion 42C of the outer cylinder 42. As a result, the vertical wall portion 124B of the reinforcing member 124 is joined to the vertical wall portion 42C of the outer cylinder 42 by the spot weld 128.

With this kind of structural member 120, the opening 126 for inserting the welding gun must be formed in the outer cylinder 42 in order to perform spot welding, so the rigidity of the area near the joining portion decreases. Also, the opening 126 may need to be dosed depending on the location, and if a plug hole for closing the opening 126 is necessary, the cost increases.

On the other hand, when joining the outer cylinder to the reinforcing member by plug welding, a through-hole must be provided in the joining portion of the outer cylinder or the like in order to perform the welding. As a result, water may get in and corrosion may occur. Also, with plug welding, the welding speed is slow, which leads to an increase in man-hours. Here, plug welding is a welding method which, when overlapping plates and joining them together, involves opening a round hole (a plug) in one of the plates, and welding and joining so as to fill in this hole.

In contrast to this, with the laser joint structure 41 of this example embodiment, there is no need to provide an opening or a through-hole in the outer cylinder 42. Also, the four surfaces of the inner cylinder 44 that is formed in one piece are joined 26 by laser welds 46 to the four surfaces of the outer cylinder 42 that is formed in one piece, so the strength and rigidity of the structural member 40 are able to be efficiently improved.

With the laser joint structure 41 in this example embodiment, the four surfaces of the inner cylinder 44 are joined by laser welds 46 to the four surfaces of the outer cylinder 42 that is formed in one piece, but the laser joint structure is not limited to this. For example, two or more surfaces of the inner cylinder 44 may be joined by laser welds 46 to two or more surfaces of the outer cylinder 42. Also, with the laser joint structure 41 of this example embodiment, the outer cylinder 42 and the inner cylinder 44 each have a rectangular shape, but they are not limited to this. For example, a circular or multi-angular outer cylinder and inner cylinder may alternatively be used.

Also, instead of the laser joint structure 41 of this example embodiment, the outer cylinder may be formed by a plurality of members that are divided in the circumferential direction, and an inner cylinder formed in one piece may be arranged inside the outer cylinder and joined thereto by a laser weld. As a result, an inner member formed in one piece is joined over multiple surfaces to a plurality of members, so strength and rigidity are able to be efficiently improved.

Also, strength and rigidity can be efficiently improved by using the structural member to which the laser joint structure according to the first and second example embodiments are applied as a vehicle frame member (such as a rocker) of an automobile, or for a vehicle structural member or the like, for example. Moreover, the inner member that is arranged inside the outer cylinder is not limited to being a reinforcing member. The laser joint structure of the invention may also be applied when connecting one member (e.g., an outer cylinder) to another member (e.g., an inner member), for example.

What is claimed is:

1. A laser joint structure comprising:
a metal outer cylinder;
a metal inner member that is provided inside of the outer cylinder, in which a joining portion is arranged following an inner shape of the outer cylinder, the joining portion being arranged contacting or close to the outer cylinder; and
a laser weld that is provided on a mating portion of the outer cylinder and a corresponding mating portion of the joining portion, and in which a circular cylindrical nugget is formed by melting the outer cylinder and the joining portion, which is accomplished by emitting a laser light from outside the outer cylinder.

2. The laser joint structure according to claim 1, wherein
a gap is formed at at least one portion between the joining portion and the outer cylinder, and a dimension of the gap is set to be within a plate thickness of the outer cylinder.

3. The laser joint structure according to claim 1, wherein
the joining portion is a plurality of flange portions that are bent from a wall portion of the inner member.

4. The laser joint structure according to claim 1, wherein
the inner member is an inner cylinder, and a plurality of the joining portions are provided on the inner cylinder.

5. The laser joint structure according to claim 1, wherein
the outer cylinder includes a plurality of members provided in a circumferential direction, and the inner member is arranged straddling the plurality of members and joined to each of the plurality of members by the joining portion.

6. The laser joint structure according to claim 1, wherein the nugget of the laser weld is formed by creating a first scan path having a generally circular shape by performing a first scan with the laser light following a weld shape centered on a center position when viewed from above, performing at least one scan with the laser light so as to create a scan path almost identical to the first scan path, creating a second scan path having a generally circular shape by performing at least one scan with the laser light to a radial inside of the first scan path, and further, creating a third scan path having a generally circular shape by performing at least one scan with the laser light to the radial inside of the second scan path.

7. A laser joining method comprising:
arranging a metal inner member having a joining portion arranged following an inner shape of a metal outer cylinder, inside of the outer cylinder, and arranging the joining portion contacting or close to the outer cylinder; and
joining a mating portion of the outer cylinder with a corresponding mating portion of the joining portion by a laser weld in which a circular cylindrical nugget is formed by melting the outer cylinder and the joining portion, which is accomplished by emitting a laser light from outside the outer cylinder onto the mating portion of the outer cylinder and the corresponding mating portion the joining portion.

8. The laser joining method according to claim 7, wherein in the joining the mating portions, creating a first scan path having a generally circular shape by performing a first scan with the laser light following a weld shape centered on a center position when viewed from above, performing at least one scan with the laser light so as to create a scan path almost identical to the first scan path, creating a second scan path having a generally circular shape by performing at least one scan with the laser light to a radial inside of the first scan path, and further, creating a third scan path having a generally circular shape by performing at least one scan with the laser light to the radial inside of the second scan path.
